(19) United States
(12) Patent Application Publication
(10) Pub. No.: US 2009/0053408 A1
(43) Pub. Date: Feb. 26, 2009

(54) METHOD FOR MANUFACTURING FILM COATED COMPOSITE LENS

(75) Inventor: SHIH-CHE CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/138,275

(22) Filed: Jun. 12, 2008

(30) Foreign Application Priority Data
Aug. 24, 2007 (CN) 200710201471.9

(51) Int. Cl. B05D 5/06

(52) U.S. Cl. 427/162

(57) ABSTRACT

In an exemplary embodiment, a method for manufacturing film coated optical lens includes: providing a lens substrate having a first surface and a second surface facing away from the first surface; forming a first lens array on the first surface, the first lens array including a plurality of first lens units; forming a second lens array on the second surface, the second lens array including a plurality of second lens units, the first lens units aligned with the respective second lens units, the first lens array, the lens substrate and the second lens array cooperatively forming a composite lens array; forming an optical film over an outer surface of the first lens array or that of the second lens array; and cutting the composite lens array into a plurality of composite lens units each including one of the first lens units, one of the second lens units, a portion of the lens substrate, and a portion of the optical film.

### BACKGROUND

1. Field of the Invention

The present invention relates to a method for manufacturing optical lenses and, particularly, to a method for manufacturing a composite lens with a film coated thereon.

2. Description of Related Art

Optical lenses, such as aspheric lenses and ball-shaped lenses are widely used as elements of lens modules. Generally, optical lenses are manufactured by injection molding. Sometimes, the lens need an optical film coated thereon so as to increase optical performance thereof. The optical film can be an anti-reflection film, an infrared ray-cut film, etc.

Referring to FIGS. 11 to 13, a conventional method for coating a surface of a lens is provided as follows:

Firstly, a tray group including a first tray 10 and a second tray 20 is provided. The first tray 10 defines a plurality of through holes 12 in rows and columns therein. Four location pins 14 protrude out from one surface of the first tray 10. The first tray 10 and second tray 20 are substantially cubic shaped. Each of the location pins 14 is disposed at one corner of the first tray 10. The second tray 20 defines a plurality of through holes 22 and four location holes 24 therein. The through holes 22 are respectively corresponding to the through holes 12. The four location holes 24 are respectively corresponding to the four location pins 14. Each of the through holes 12 and 22 is in a shape of circular truncated cone. Each of the location pins 14 is configured for inserting through the corresponding location hole 24, so as to fix the first tray 10 and the second tray 20 together. The plurality of through holes 12 cooperate with the plurality of holes 22 to define a plurality of spaces 26. The opening 122 of each of the through holes 12 adjacent to the second tray 20 is wider than the corresponding opening 124 of the through holes 12 away from the second tray 20. Similarly, opening 222 of each of the through holes 22 adjacent to the first tray 10 is wider than the corresponding opening 224 of the through holes 22 away from the first tray 10. A plurality of lenses 30 is received in the spaces 26.

Secondly, the surfaces of the lenses 30 are coated with functional materials by sputtering or other coating methods, and the functional films are formed on the surfaces of the lenses 30. As shown in FIG. 13, because each of the openings 224 is narrower than each of the corresponding openings 222, peripheral areas of the surface of the lens 30 may fail to be coated with the functional material. Thus, the optical performance of the lenses 30 may be weakened.

What is needed, therefore, is a method for manufacturing a lens with an optical film coated thereon.

### SUMMARY

In an exemplary embodiment, a method for manufacturing film coated optical lens includes: providing a lens substrate having a first surface and a second surface facing away from the first surface; forming a first lens array on the first surface, the first lens array including a plurality of first lens units; forming a second lens array on the second surface, the second lens array including a plurality of second lens units, the first lens units aligned with the respective second lens units, the first lens array, the lens substrate and the second lens array cooperatively forming a composite lens array; forming an optical film over an outer surface of the first lens array or that of the second lens array; and cutting the composite lens array into a plurality of composite lens units each including one of the first lens units, one of the second lens units, a portion of the lens substrate, and a portion of the optical film.

Advantages and novel features will become more apparent from the following detailed description of the present method for manufacturing a lens with an optical film coated, when taken in conjunction with the accompanying drawings.

### BRIEF DESCRIPTION OF THE DRAWINGS

Many aspects of the present method for manufacturing a film coated lens can be better understood with reference to the following drawings. The components in the drawings are not necessarily drawn to scale, the emphasis instead being placed upon clearly illustrating the principles of the present method for manufacturing a film coated lens. Moreover, in the drawings, like reference numerals designate corresponding parts throughout the several views.

FIG. 1 is a flow chart of a method for manufacturing a film coated composite lens in accordance with a present embodiment.

FIGS. 2 to 4 illustrates the process of forming the first lens array on one surface of the lens substrate.

FIGS. 5 to 7 illustrate the process of forming the second lens array on the other surface of the lens substrate.

FIG. 8 is a schematic, perspective view of a composite lens array which is formed from the molding process illustrated in FIGS. 2-7.

FIG. 9 is a schematic, perspective view of the composite lens array in the FIG. 8 with an optical film coated thereon.

FIG. 10 is a schematic, perspective view of a plurality of composite lenses which is achieved after cutting the composite lens array with an optical film coated thereon in FIG. 9.

FIG. 11 is an exploded perspective view of a conventional tray group including a first tray and a second tray and a plurality of lenses in accordance with a related art.

FIG. 12 is a schematic, front view of the tray group in FIG. 11 assembled.

FIG. 13 is a schematic, cross-sectional view of the FIG. 12 along the line XIII-XIII.

### DETAILED DESCRIPTION OF EMBODIMENTS

Reference will now be made to the drawings to describe exemplary embodiments of the method for manufacturing a film coated lens.

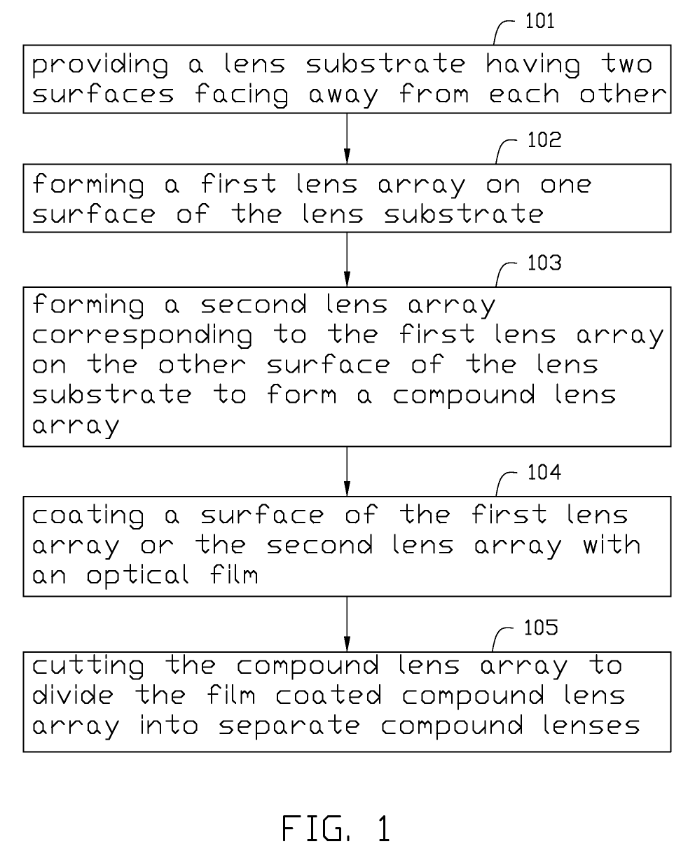

Referring to FIG. 1, a method for manufacturing a lens with an optical film coated thereon is provided in accordance with a present embodiment. The method includes the following steps: providing a lens substrate having two surfaces facing away from each other (step 101); forming a first lens array on one surface of the lens substrate (step 102); forming a second lens array corresponding to the first lens array on the other surface of the lens substrate to form a composite lens array (step 103); coating a surface of the first lens array or the second lens array with an optical film (step 104); cutting the composite lens array to divide the film coated composite lens array into separate composite lenses (step 105).

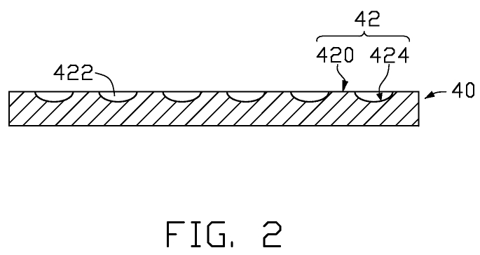

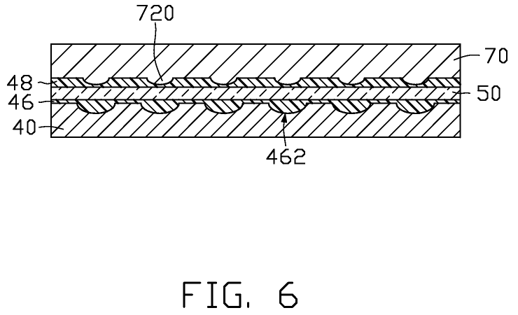

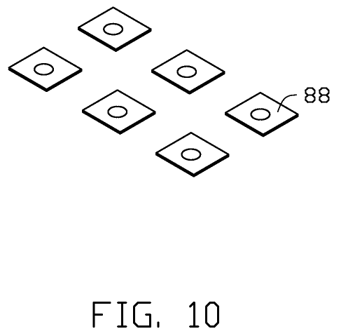

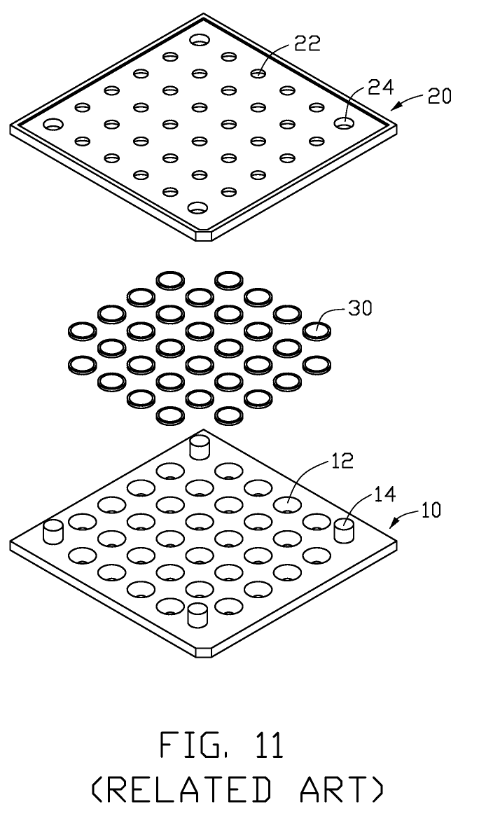

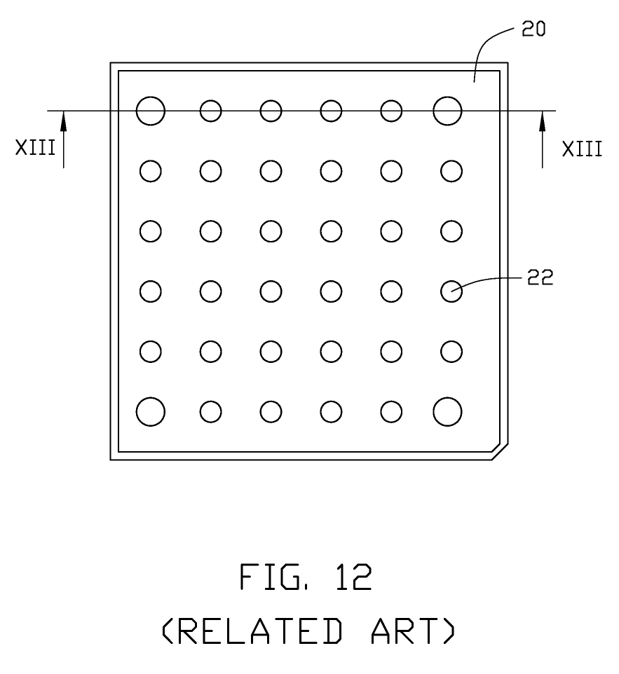

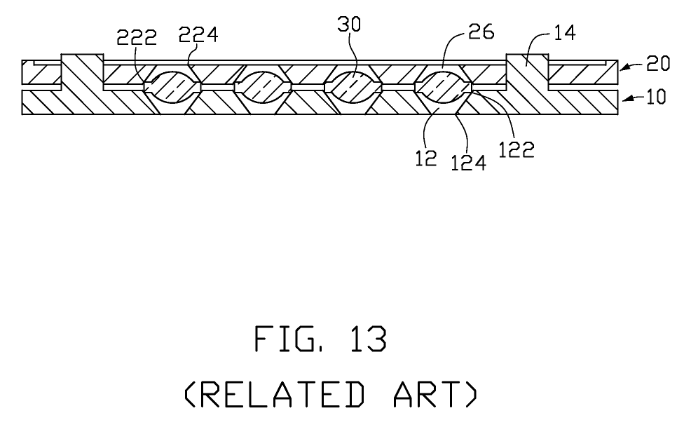

Referring to FIGS. 2 to 10, the following describes the method for manufacturing a composite lens with an optical film coated thereon in detail.

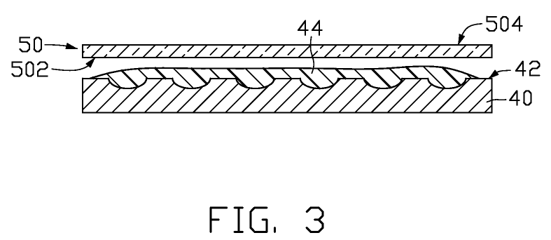

In step 101, the lens substrate 50 (refer to FIG. 3) having a predetermined thickness is provided. The thickness of the lens substrate 50 can vary according to needs. The lens substrate 50 has two surfaces 502 and 504 facing away from each other. The lens substrate 50 is made of glass or an optical plastic material, which can be selected from a group consisting of polymethyl methacrylate (PMMA), polystyrene, a copolymer of cinnamene and acrylate, polycarbonate, etc.

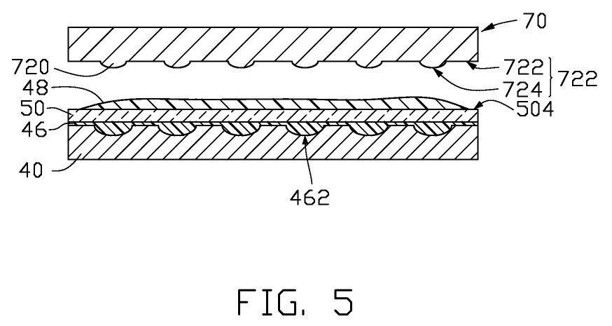

Referring to FIGS. 2 to 4, in step 102, a first lens array 46 (referring to FIG. 5) is formed on one surface 502 of the lens substrate 50 in the following steps.

Firstly, a first mold half 40 is provided. The first mold half 40 has a first molding surface 42. The first molding surface 42 includes a plane surface 420. A plurality of concave portions 422 is defined on the plane surface 420. Each of the concave portions 422 has a concave surface 424. The plurality of concave portions 422 is arranged in columns and rows.

Secondly, a fused molten mass of resin 44 is placed on the first molding surface 42 by method of deposition, spray painting, etc. The resin 44 can be solidified by ultraviolet light.

Thirdly, the surface 502 of the lens substrate 50 is set facing the first molding surface 42. The lens substrate 50 is moved toward the first molding surface 42 and pressed firmly against the first mold half 40 till the gap between the first molding surface 42 and the surface 502 is filled with the resin 44.

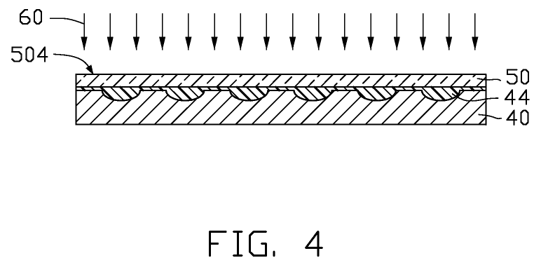

Finally, referring to FIG. 4, ultraviolet light 60 strikes the surface 504 of the lens substrate 50, transmits through the lens substrate 50 and the resin 44, and the resin 44 is solidified by the ultraviolet light 60. In this way, the first lens array 46 is formed on the surface 502 of the lens substrate 50.

Referring to FIGS. 5 to 8, in step 103, a second lens array 49 is formed on the other surface of the lens substrate in the following steps.

Firstly, a second mold half 70 is provided. The second mold half 70 has a second molding surface 72. The second molding surface 72 includes a plane surface 722. A plurality of protrusions 720 protrudes out from the plane surface 722. Each of the protrusions 720 has a curved surface 724. Each of the concave surfaces 424 and curved surfaces 724 can be a spherical surface or an aspheric surface and has a central axis. The number of the concave surfaces 424 is same as that of the curved surfaces 724. Each concave surface 424 corresponds to one curved surface 724. Each concave surface 424 and the corresponding curved surface 724 are coaxial. It is to be understood that the shape of the first molding surface 42 and the second molding surface 72 can vary according to needs, for example, one of the first molding surface 42 and the second molding surface 72 can be a flat surface.

Secondly, a fused molten mass of resin 48 is placed on the surface 504 of the lens substrate 50 by method of deposition, spray painting, etc. The resin 48 can be solidified with ultraviolet light.

Thirdly, the second molding surface 72 is set facing to the surface 504 of the lens substrate 50. The second mold half 70 is moved toward the lens substrate 50 and pressed firmly against the lens substrate 50 till the gap between the second molding surface 72 and the surface 504 is filled with the resin 48.

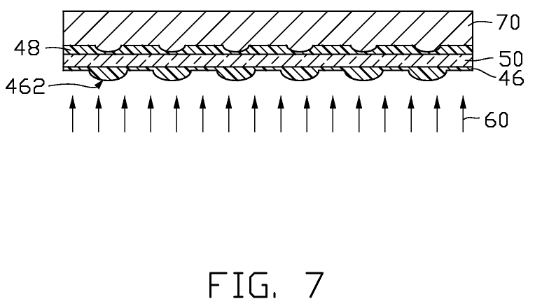

Finally, referring to FIG. 7, the first mold half 40 is remolded. An ultraviolet light 60 incidents on the surface 462 of the first lens array 46, transmits through the first lens array 46, the lens substrate 50 and the resin 48, and the resin 48 is solidified by the ultraviolet light 60. In this way, the second lens array 49 is formed on the surface 504 of the lens substrate 50.

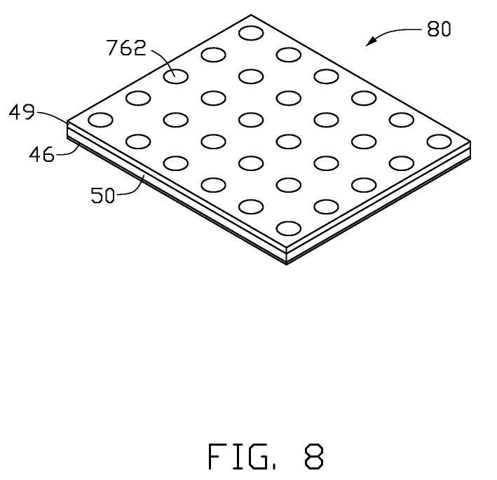

Referring to FIG. 8, a composite lens array 80 is formed after both the first mold half 40 and the second mold half 70 are separated from the lens substrate 50. The composite lens array 80 is a collection of the first lens array 46, the lens substrate 50, and the second lens array 49 being placed in contact one after the other. In other words, the composite lens array 80 is a plurality of composite lenses integrally connected with each other and arranged in an array. The surfaces of the first lens array 46 and the second lens array 49 can be in different shapes and can be made of materials of different refractive indices.

Corresponding to coaxiality between each concave portions 422 and the corresponding protrusion 720, two corresponding surfaces of each composite lens are coaxial. It is to be understood that the composite lens array 80 may also be manufactured by other methods, e.g. injection molding, casting.

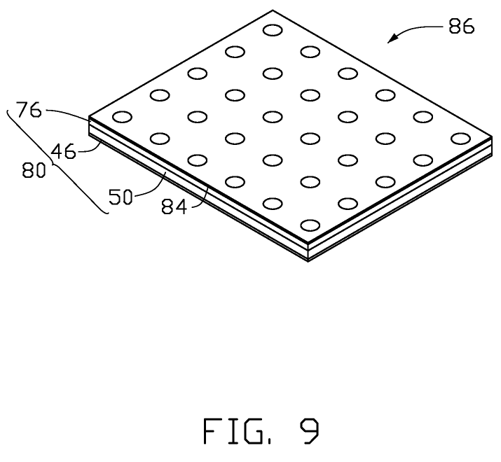

In step 104, the composite lens array 80 is disposed in a vacuum evaporation device (not shown) to coat one surface of the composite lens array 80 with an optical film 84. Referring to FIG. 9, after the composite lens array 80 being coated with the optical film 84, an optical element 86 including the composite lens array 80 and the optical film 84 is formed. The optical film 84 can be selected from a group consisting of anti-reflective film, infrared-cut film, etc. The optical film 84 can be a single-layer film or a multi-layer film. It is to be understood that the other surface of the composite lens array 80 can also be coated with film. Furthermore, the surface of the composite lens array 80 also can be coated by other methods, such as sputtering, etc.

Referring to FIG. 9, in step 105, the optical element 86 is cut by a wafer dicing saw (not shown). The composite lenses 88 integrally connected with each other are divided into single composite lenses 88. Each of the composite lenses 88 has two surfaces. After this step, the film coated composite lens 88 is formed. In this step, the wafer dicing saw can be selected from a group consisting of quartz wafer dicing saw and silicon wafer dicing saw. Also, the optical element 63 can be cut by other device, such as laser cutting machine.

One of the advantages of the method for manufacturing film coated composite lens is that the optical film covers the entire surface of the composite lens because of no shelter over the surface of the composite lens when coating, thus the composite lens with optical film coated has high optical performance.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a film coated composite lens comprising steps:
providing a lens substrate having a first surface and a second surface facing away from the first surface;
forming a first lens array on the first surface, the first lens array including a plurality of first lens units;
forming a second lens array on the second surface, the second lens array including a plurality of second lens units, the first lens units aligned with the respective second lens units, the first lens array, the lens substrate and the second lens array cooperatively forming a composite lens array;
forming an optical film over an outer surface of the first lens array or that of the second lens array; and
cutting the composite lens array into a plurality of composite lens units each including one of the first lens units, one of the second lens units, a portion of the lens substrate and a portion of the optical film.

2. The method as claimed in claim 1, wherein a material of the lens substrate includes optical plastics or glass.

3. The method as claimed in claim 1, wherein the first lens units are arranged in columns and rows.

4. The method as claimed in claim 1, wherein a method for manufacturing the first lens array or the second lens array is selected from the group consisting of hot press molding, injection molding, casting.

5. The method as claimed in claim 1, wherein the step of forming the first lens array comprises:
providing a first mold half having a first molding surface, a plurality of recesses or protrusions arranged in columns and rows being defined in the first molding surface, each of the recesses or protrusions having a central axis;
placing a molten resin on the first surface of the lens substrate;
pressing the first mold half toward the lens substrate till a gap between the first mold half and the lens substrate is filled with the resin; and
solidifying the resin using ultraviolet light.

6. The method as claimed in claim 5, wherein the step of forming the second lens array comprise steps:
providing a second mold half having a second molding surface, a plurality of recesses or protrusions arranged in columns and rows being defined in the second molding surface, each of the recesses or protrusions having a central axis;
placing a molten resin on the second surface of the lens substrate;
pressing the second mold half toward the lens substrate till a gap between the second mold half and the lens substrate is filled with the resin; and
solidifying the resin using ultraviolet light.

7. The method as claimed in claim 6, wherein the recesses or protrusions of the first molding surface are coaxially aligned with the recesses or protrusions of the second molding surface respectively.

8. The method as claimed in claim 1, wherein a method of forming the optical film is selected from the group consisting of evaporation coating and sputtering.
